(19) United States
(12) Patent Application Publication
(10) Pub. No.: US 2024/0278502 A1
(43) Pub. Date: Aug. 22, 2024

(54) SYSTEM AND COMPUTER-ASSISTED METHOD FOR ADDITIVELY MANUFACTURING A COMPONENT

(71) Applicant: KRONES AG, Neutraubling (DE)

(72) Inventors: Johannes KARL, Reichenstetten (DE); Klaus GERLACH, Regensburg (DE); Bernd BALDAUF, Alteglofsheim (DE)

(21) Appl. No.: 18/572,024

(22) PCT Filed: Jun. 20, 2022
(86) PCT No.: PCT/EP2022/066671

§ 371 Date: Dec. 19, 2023

(30) Foreign Application Priority Data
Jun. 24, 2021 (DE) 102021116385.4

(51) Int. Cl. B29C 64/386; B33Y 50/00

(52) U.S. Cl. CPC B29C 64/386; B33Y 50/00

(57) ABSTRACT

The invention relates to, inter alia, an installation including a first computing infrastructure with a web server which is configured to provide a user interface by means of which a component can be selected by a user logged into the web server, and a second computing infrastructure which can be connected to a plurality of additive manufacturing devices in a plurality of local networks for operating the additive manufacturing devices. The first computing infrastructure sends to the second computing infrastructure instructions which prompt an additive manufacturing device to additively manufacture the selected component in a multiplicity of layers, and a manufacturer identifier which references an additive manufacturing device associated with the logged-in user. The second computing infrastructure receives the instructions and the manufacturer identifier and instructs the additive manufacturing device referenced in the received manufacturer identifier to additively manufacture the selected component according to the received instructions.

### TECHNICAL FIELD

The invention relates to a system and a computer-assisted method for additively manufacturing a component.

### TECHNICAL BACKGROUND

The use of additive manufacturing for the on-site supply of customers with replacement parts or wearing parts has the potential of considerably reducing installation downtimes and storage costs. For example, the customer can additively manufacture a corresponding replacement part or wearing part for the installation directly on site when the part is required.

For example, DE 10 2015 006 512 A1 discloses a method for manufacturing replacement parts for a machine for manufacturing packaging for a smokable product packaging machine with the following steps: a) encrypting digital production data required for the production of the replacement part, b) transmitting the encrypted production data from a first computing unit, in particular associated with the manufacturer of the machine, to a second computing unit, in particular associated with the user of the machine, by remote data transmission, preferably via a communication network such as the internet, c) decrypting the transmitted, encrypted production data, d) manufacturing the replacement part with a replacement part manufacturing device associated with the machine user and comprising a 3D printer, doing so on the basis of the transmitted production data.

For example, DE 10 2019 109 655 A1 discloses a method for the additive manufacturing of at least one component with defined component properties, comprising the steps: —providing at least one certified data set which contains component-specific parameters, system-specific parameters and process-specific parameters certified by a supplier for an additive manufacturing process of at least one specific component with defined component properties, —using at least one additive manufacturing process for the additive manufacturing of at least one specific component with defined component properties on the basis of the at least one certified data set.

The invention is based on the object of providing an improved technique for communicating with an additive manufacturing device.

### SUMMARY OF THE INVENTION

The object is achieved by the features of the independent claims. Advantageous developments are specified in the dependent claims and the description.

A first aspect of the present disclosure relates to a system having a first computing infrastructure (e.g., server computing infrastructure) with a web server that is configured to provide a user interface by means of which a component can be selected by a user logged into the web server. The system has a second computing infrastructure connectable to a plurality of additive manufacturing devices of a plurality of local networks in order to operate the additive manufacturing devices. The first computing infrastructure is configured to send instructions that prompt an additive manufacturing device to additively manufacture the selected component in a plurality of layers, and a manufacturer identifier which references an additive manufacturing device associated with the logged-in user, to the second computing infrastructure. The second computing infrastructure is configured to receive the instructions and the manufacturer identifier and instruct the additive manufacturing device (e.g., a local network) referenced in the received manufacturer identifier to additively manufacture the selected component according to the received instructions.

Advantageously, the method allows particularly effective communication for supplying any additive manufacturing device of a plurality of possible additive manufacturing devices with instructions to additively manufacture a specific component. On the one hand, this can merely require a simple selection of the component by the logged-in user. On the other hand, the system can then automatically take over complete communication in order to ultimately produce the selected component by means of the desired additive manufacturing device. While the first computing infrastructure can, for example, provide a customer portal for a large number of customers via the user interface, the second computing infrastructure can be used, for example, to map a digital factory, and this for a large number of systems corresponding to the large number of local networks. Efficient communication in an integrative approach can therefore be made possible which can function particularly efficiently and safely in a system with the incorporation of a plurality of installations and their additive manufacturing devices. The reduction of the user input to, for example, only the selection of the component also reduces a risk of operating errors. The communication that takes place in response to the selection of the control unit can also occur very securely and ensure, for example, that communication only takes place with the additive manufacturing device in the respective local network so that, for example, there is also no security risk for other network components of the local network. Particularly advantageously, the system can be used in environments in which a plant operator uses an additive manufacturing device for producing replacement parts or wearing parts for the system, wherein these replacement parts or wearing parts can be managed via the first computing infrastructure associated with the manufacturer of the system, and wherein the first computing infrastructure coordinates the production of the replacement part or wearing part with the second computing infrastructure which is assigned to the manufacturer of the additive manufacturing device. The exemplary embodiments described below can enable particularly effective exploitation of the described advantages.

In one embodiment, the second computing infrastructure has a data memory, preferably a cloud data memory, and the second computing infrastructure is configured to send an address, preferably a URL address, of the data memory to the first computing infrastructure. The first computing infrastructure is configured to receive the sent address and to send the instructions to the received address of the data memory.

In a further exemplary embodiment, the second computing infrastructure is configured to send the address of the data memory to the additive manufacturing device referenced in the manufacturer identifier, preferably after the first computing infrastructure has sent the instructions to the address of the data memory.

In a further exemplary embodiment, the second computing infrastructure is configured to instruct the additive manufacturing device indicated in the manufacturer identifier to load the instructions from the sent address (e.g., after the first computing infrastructure has sent the instructions to the address of the data memory).

In a further exemplary embodiment, the second computing infrastructure is configured to instruct the additive manufacturing device referenced in the manufacturer identifier to additively manufacture the selected component according to the instructions after it has loaded the instructions from the sent address.

In one embodiment, the first computing infrastructure is configured to send a request to the second computing infrastructure in response to a selection of the component by a user logged into the web server. The second computing infrastructure is configured to send to the first computing infrastructure, in response to the request, an order identifier for referencing a manufacturing order for the additive manufacturing of the selected component.

In a further embodiment, the second computing infrastructure is configured to send the address together with the order identifier to the first computing infrastructure.

In one embodiment variant, the additive manufacturing device associated with the logged-in user is specified by a data set which is stored in the first computing infrastructure (12) (and has been created, for example, by an administrator) and/or which can be selected, specified and/or changed by the logged-in user by means of the user interface.

In a further embodiment variant, the component can be selected from a group of components by the user logged into the web server by means of the user interface, wherein instructions which cause an additive manufacturing device to additively manufacture the respective component in a plurality of layers are stored in a data memory of the first computing infrastructure for each selectable component of the group.

In one exemplary embodiment, the second computing infrastructure is configured to communicate with the plurality of additive manufacturing devices via a virtual private network (VPN), preferably only in each case exclusively with the plurality of additive manufacturing devices within the plurality of local networks.

In a further exemplary embodiment, the first computing infrastructure is configured to authenticate itself to the second computing infrastructure, and the second computing infrastructure is configured to authentificate the authenticating first infrastructure, preferably by means of an access token.

In a further exemplary embodiment, the second computing infrastructure is configured to receive from the additive manufacturing device referenced in the manufacturing identifier an execution status indicating a status of an additive manufacturing of the selected component and to send the received execution status to the first computing infrastructure.

In a further exemplary embodiment, the first computing infrastructure is configured to receive the execution status sent by the second computing infrastructure and to adjust an access right with which a selection of the component for the logged-in user is enabled, depending on the received execution status.

In a further exemplary embodiment, an access right with which a selection of the component is enabled is can be modified via the user interface by the user logged into the web server.

In one exemplary embodiment, the first computing infrastructure is associated with a manufacturer of an installation, preferably a production installation, particularly preferably a container-processing installation, and/or the second computing infrastructure is associated with a manufacturer of the additive manufacturing device (e.g., the additive manufacturing device referenced in the production identifier). Optionally, the additive manufacturing device (e.g. the additive manufacturing device referenced in the manufacturing identifier) can be arranged or be operable as a wearing part and/or replacement part supplier in an installation of the manufacturer that is associated with the first computing infrastructure.

In a further exemplary embodiment, the component to be additively manufactured is a replacement part or a wearing part of a container-processing installation for processing containers, preferably a format part, a container guide rail, a container guide, a container holder or a container clamp.

It is possible for the system to have an installation, preferably a production installation, particularly preferably a container-processing installation. Optionally, the additive manufacturing device referenced in the production identifier can be arranged or be operable in the system, e.g. as a wearing part supplier and/or replacement part supplier for the installation.

Preferably, the container-processing installation can be designed for manufacturing, cleaning, checking, filling, closing, labeling, printing, and/or packaging containers for liquid media, preferably beverages or liquid foodstuffs.

For example, the containers can be configured as bottles, cans, canisters, cartons, vials, etc.

A further aspect of the present disclosure relates to a computer-assisted method for additively manufacturing a component, preferably a container-processing installation. The method comprises providing a first computing infrastructure (e.g., a server computing infrastructure) with a web server providing a user interface. The method comprises providing a second computing infrastructure (e.g., a server computing infrastructure) that is connectable to a plurality of additive manufacturing devices of a plurality of local networks for operating the additive manufacturing devices. The method comprises receiving by means of the first computing infrastructure a selection of a component which has been selected by means of the user interface from a user logged into the web server. The method comprises sending instructions from the first computing infrastructure to the second computing infrastructure that prompt an additive manufacturing device to additively manufacture the selected component in a plurality of layers. The method comprises sending from the first computing infrastructure to the second computing infrastructure a manufacturer identifier that references an additive manufacturing device associated with the logged-in user. The method comprises a reception of the sent instructions by the second computing infrastructure. The method comprises a reception of the sent manufacturer identifier by the second computing infrastructure. The method comprises instructing by means of the second computing infrastructure the additive manufacturing device referenced in the received manufacturer identifier to additively manufacture the selected component according to the received instructions. Advantageously, the method can achieve the same advantages that have already been described with respect to the system.

Preferably, the method can use the system disclosed herein.

The preferred embodiments and features of the invention described above can be combined with one another as desired.

### BRIEF DESCRIPTION OF THE DRAWINGS

Further details and advantages of the invention are described below with reference to the accompanying drawings. In the figures:

FIG. 1 shows a schematic representation of a system according to an exemplary embodiment of the present disclosure; and

FIG. 2 shows a schematic representation of a communication strategy between two computing infrastructures and an additive manufacturing device according to an exemplary embodiment of the present disclosure.

The embodiments shown in the drawings correspond at least in part, so that similar or identical parts are provided with the same reference signs and reference is also made to the description of other embodiments or figures for the explanation thereof to avoid repetition.

### DETAILED DESCRIPTION OF EMBODIMENTS

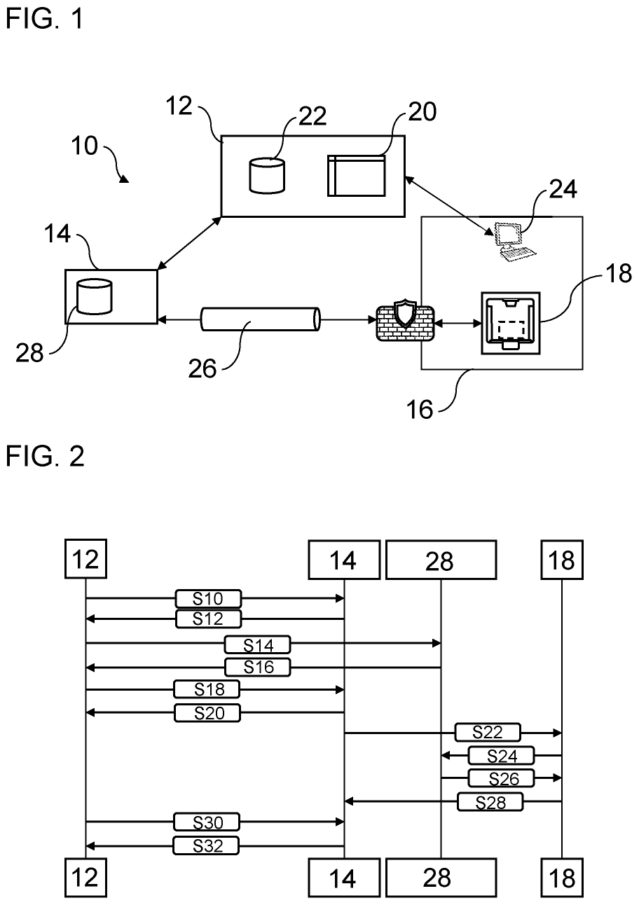

FIG. 1 shows a system 10. The system 10 has a first computing infrastructure 12 and a second computing infrastructure 14. Furthermore, a local network 16 having an additive manufacturing device 18 is included.

The first computing infrastructure 12, the second computing infrastructure 14 and the local network 16 are preferably formed separately from one another and optionally spatially separated from one another.

The local network 16 can represent a plurality of local networks 16, wherein only one local network 16 in FIG. 1 is shown schematically for reasons of clarity. Depending on the formation of the system boundary of the system 10, the local network 16 can be included in the system 10 or be connected to the system 10.

The first computing infrastructure 12 can communicate with the second computing infrastructure 14 (e.g., only) via the second computing infrastructure 14 with the additive manufacturing device 18 and with a computer 24.

The first computing infrastructure 12 has a web server with a user interface 20. The first computing infrastructure 12 can have a data memory 22.

A user can log into the web server by means of the computer 24 via the user interface 20, e.g. password-protected. The computer 24 can, for example, be comprised in the local network 16 or be arranged externally to the local network 16. The computer 24 is preferably a personal computer (PC). The computer 24 can serve as a user interface with which the user can communicate with the first computing infrastructure 12 via the user interface 20 of the web server.

Via the user interface 20, the user logged into the web server can select a component which is to be manufactured additively. Specifically, the operator can select via the user interface 20, for example, a graphical and/or textual representation of the component. The graphical and/or textual representation of the component can be stored in the data memory 22.

It is possible for the user to select the component from a group of components. For the component and optionally the other components of the group, instructions can be stored in the data memory 22 that prompt an additive manufacturing device (e.g., the additive manufacturing device 18) to additively manufacture the respective component in a plurality of layers. The instructions can be sent from the first computing infrastructure 12 to the second computing infrastructure 14.

It is also possible for the first computing infrastructure 12 to submit a suggestion for one or more selectable components to the user via the user interface 20. The first computing infrastructure 12 can create the suggestion, for example on the basis of the group of components, on the basis of a user profile of the user and/or on the basis of earlier user interactions of the user with the user interface 20 or with the first computing infrastructure 12. The user profile and/or information regarding the earlier user interactions can be stored in the data memory 22.

Particularly preferably, the component and optionally the group of components are a replacement part or a wearing part of a container processing installation for processing containers. The component can preferably, for example, be a format part (or fitting) which is matched to a container format of a plurality of different container formats with which the container processing installation can be operated (for example with respect to a container shape, a container size and/or a container diameter). Alternatively, the component can be, for example, a container guide rail, a container guide, a container holder or a container clamp. However, it is also possible for the component to be a replacement part or wearing part of a different type of (e.g., production) installation.

The additive manufacturing device 18 is assigned to the user. The assignment can be specified in the form of a data set and, for example, be stored in the data memory 22. The data set can have a manufacturer identifier with which the additive manufacturing device 18 can be uniquely identified. The assignment can be specified, for example, by an administrator of the first computing infrastructure 12. Alternatively or additionally, it is possible for the user, for example by means of the user interface 20, to select, indicate and/or change the additive manufacturing device 18 for manufacturing the selected component or the component still to be selected.

The first computing infrastructure 12 can send the manufacturer identifier to the second computing infrastructure 14.

The second computing infrastructure 14 can communicate with the first computing infrastructure 12 and with the plurality of local networks, in each case having at least one additive manufacturing device, e.g., with the local network 16 and the additive manufacturing device 18. It is possible for information transmitted to the second computing infrastructure 14 and/or received by the second computing infrastructure 14 to be encrypted during the transmission and in the memory. For example, the communication can use safe HTFPS connections with 4095 bit REA encryption according to the industry standard.

For communication with the first computing infrastructure 12, the first computing infrastructure 12 can authenticate itself to the second computing infrastructure 14, e.g., with corresponding access data, a key, etc. The second computing infrastructure 14 can authentificate the authenticating first infrastructure 12. The second computing infrastructure 14 can send, for example, an access token or, for example, job instance (UUID) to the first computing infrastructure 12 if the authentification was successful.

For communicating with the local network 16 or the local networks, the second computing infrastructure 14 can use a virtual private network (VPN) 26 or a VPN tunnel. For example, a secure https connection can be established between the second computing infrastructure 14 and the additive manufacturing device 18 via the virtual private network 26. The local network 16 can have a firewall which, for example, provides only a prespecified port for communication exclusively with the additive manufacturing device 18. The exclusive communication link can preclude the second computing infrastructure 14 from communicating with other network components of the local network 16 apart from the additive manufacturing device 18.

The second computing infrastructure 14 is preferably a cloud computing infrastructure. The second computing infrastructure 12 can operate the additive manufacturing device 18 for additive manufacturing of the component according to the received instructions.

The second computing infrastructure 14 can have a data memory 28, preferably a cloud data memory. For example, the instructions received by the first computing infrastructure 14 can be stored in the data memory 28 for the additive manufacturing of the component.

The local network 16 can have a plurality of network components, among other things the additive manufacturing device 18 and possibly the computer 24. The local network 16 is preferably a local network of a container-processing installation. It is also possible for the local network to be a local network of another type of (e.g., production) installation in which components manufactured by means of the additive manufacturing device 18 can be used as a replacement part of the wearing parts.

The additive manufacturing device 18 can on the basis of the instructions manufacture or produce the selected component in a plurality of (material) layers from supplied (e.g., plastic) material (e.g., in filament form).

In the following, with particular reference to FIG. 2, an example will be described of communication between the first computing infrastructure 12, the second computing infrastructure 14 and the additive manufacturing device 18 for the additive manufacturing of a component. It is possible to implement the method in reduced form with fewer than method steps S10 to S32 or in expanded form with additional method steps.

After a user has selected in the user interface 20 a component to be additively manufactured, the computing infrastructure 12 can in step S10 send a request to the second computing infrastructure 14. The second computing infrastructure 14 can receive the sent request. For example, an order identifier (e.g. job ID), with which the manufacturing order can be uniquely identified, can be requested. An address of the data memory 28 can also be requested. The request can also comprise information regarding the instructions for the additive manufacturing of the selected component in a plurality of layers, e.g. a file size of a file having the instructions.

In a step S12, the second computing infrastructure 14 can send an order identifier (e.g., job ID), with which the manufacturing order can be uniquely identified, to the first computing infrastructure 12. An address, preferably a URL address, of the data memory 28 in which the instructions for the additive manufacturing are to be stored, can also be sent from the second computing infrastructure 14 to the first computing infrastructure 12. The first computing infrastructure 12 can receive the order identifier and/or the address.

In a step S14, the first computing infrastructure 12 can send the instructions that prompt the additive manufacturing device 18 to build the selected component in a plurality of layers to the received address for storing in the data memory 28. The instructions can, for example, be present or be sent in the form of a file readable by the additive manufacturing device 18. The data memory 28 can receive the sent instructions.

In a step S16, the data memory 28 can send a confirmation to the first computing infrastructure 12 that the instructions have been completely received. The confirmation can further comprise an address of the instructions in the data memory 28 from which the instructions can be directly retrieved.

In a step S18, the first computing infrastructure 12 can send a manufacturer identifier to the second computing infrastructure 14. The manufacturer identifier can reference the additive manufacturing device 18 by which the component is to be additively manufactured. The manufacturer identifier or the respective additive manufacturing device 18 can, for example, be assigned to the selecting user or be specified by the user, as already explained. The first computing infrastructure 12 can send the manufacturer identifier together with the previously received order identifier to the second computing infrastructure 14 in order to enable, for example, a corresponding assignment for the second computing infrastructure 14. The second computing infrastructure 14 can receive the manufacturer identifier and optionally the order identifier.

In a step S20, the second computing infrastructure 14 can send a status message of the additive manufacturing device 18 referenced in the manufacturer identifier to the first computing infrastructure 12, optionally together with the order identifier. The status message can, for example, indicate whether the referenced additive manufacturing device 18 is switched on, available, ready for operation, and/or connected to the second computing infrastructure 14. The first computing infrastructure 12 can receive the status message and optionally the order identifier.

In a step S22, the second computing infrastructure 14 of the additive manufacturing device 18 referenced in the manufacturer identifier can send the address of the data memory 28 for loading the instructions. The second computing infrastructure 14 can prompt the additive manufacturing device 18 referenced in the manufacturer identifier to load the instructions from the sent address. The second computing infrastructure 14 can prompt the additive manufacturing device 18 referenced in the manufacturer identifier to additively manufacture the component according to the instructions. The additive manufacturing device 18 can receive the sent information (address and optionally instruction to load and/or instruction to manufacture) from the second computing infrastructure 14.

In a step S24, the additive manufacturing device 18 can start loading the instructions from the received address of the data memory 28.

In a step S26, the instructions are transmitted from the data memory 28 to the additive manufacturing device 18.

After loading or receiving the instructions, the additive manufacturing device 18 can begin to additively manufacture the selected component in a plurality of layers.

In a step S28, the additive manufacturing device 18 can send an execution status regarding the manufacture of the component to the second computing infrastructure 14. For example, at prespecified intervals (e.g. in a range between about 5 s and 360 s, preferably about 10 s), a (current or updated) execution status can be sent by the additive manufacturing device 18. The execution status can indicate a manufacturing progress or a printing progress of the component, e.g. as a percentage value. The second computing infrastructure 14 can receive the sent execution status and optionally send it to the first computing infrastructure 12. In a step S30, the first computing infrastructure 12 can send a status request regarding the additive manufacturing device 18 referenced in the manufacturer identifier to the second computing infrastructure 14, e.g. whether the component is currently being manufactured, how far the component has already been manufactured, whether additive manufacturing of the component has already been completed, or whether an error has occurred during additive manufacturing. The second computing infrastructure 14 can receive the status request.

In a step S32, the second computing infrastructure 14 can send a status message regarding the additive manufacturing device 18 to the first computing infrastructure 12, e.g. whether the component is currently being manufactured, how far the component has already been manufactured, whether additive manufacturing of the component has already been completed, or whether an error has occurred during additive manufacturing.

The first computing infrastructure 12 can receive the status message. Information regarding the received status message can be output to the operator, for example via the user interface 20.

It is also possible that, on the basis of information from the status message, an access right for the user to select the component or release it is adjusted in response to the status message. For example, the access right or the approval can be withdrawn if the status message indicates that the component has been completely manufactured. On the other hand, the access right can also be changed in such a way that an available number for a selectability of the component is reduced, e.g. by one if a component has been additively manufactured. It is possible that the user can adapt his access right, e.g., can increase the available number, e.g., by means of an on-line payment system.

The invention is not limited to the preferred exemplary embodiments described above. Rather, a plurality of variants and modifications are possible which likewise make use of the inventive concept and therefore fall within the scope of protection. In particular, the invention also claims protection for the subject-matter and the features of the dependent claims, irrespective of the claims to which they refer. In particular, the individual features of independent claim 1 are each disclosed independently of one another. All ranges specified herein are to be understood as disclosed in such a way that all values falling within the respective range are individually disclosed, e.g., also as the respective preferred narrower outer limits of the respective range.

### LIST OF REFERENCE SIGNS

10 System
12 First computing infrastructure
14 Second computing infrastructure
16 Local network
18 Additive manufacturing device (e.g. 3D printer)
20 User interface
22 Data memory
24 Computer
26 Virtual private network
28 Data memory
S10-S32 Method steps

1-15. (canceled)

16. A system comprising:
a first computing infrastructure with a web server that is configured to provide a user interface for a component selection by a user logged into the web server,
a second computing infrastructure that is connectable to a plurality of additive manufacturing devices of a plurality of local networks for operating the additive manufacturing devices,
wherein:
the first computing infrastructure is configured to send instructions, which prompt an additive manufacturing device to additively manufacture the selected component in a plurality of layers, and a manufacturer identifier, which references an additive manufacturing device associated with the logged-in user, to the second computing infrastructure, and
the second computing infrastructure is configured to receive the instructions and the manufacturer identifier and prompt the additive manufacturing device referenced in the received manufacturer identifier to additively manufacture the selected component according to the received instructions.

17. The system according to claim 16, wherein:
the second computing infrastructure has a data memory,
the second computing infrastructure is configured to send an address of the data memory to the first computing infrastructure, and
the first computing infrastructure is configured to receive the sent address and to send the instructions to the received address of the data memory.

18. The system according to claim 17, wherein:
the data memory includes a cloud data memory, and the address includes a URL address.

19. The system according to claim 17, wherein:
the second computing infrastructure is configured to send the address of the data memory to the additive manufacturing device referenced in the manufacturer identifier.

20. The system according to claim 19, wherein the second computing infrastructure is configured to send the address of the data memory to the additive manufacturing device referenced in the manufacturer identifier after the first computing infrastructure has sent the instructions to the address of the data memory.

21. The system according to claim 19, wherein:
the second computing infrastructure is configured to prompt the additive manufacturing device referenced in the manufacturer identifier to load the instructions from the sent address; and optionally
the second computing infrastructure is configured to prompt the additive manufacturing device referenced in the manufacturer identifier to additively manufacture the selected component according to the instructions after it has loaded the instructions from the sent address.

22. The system according to claim 16, wherein:
the first computing infrastructure is configured to send a request to the second computing infrastructure in response to a selection of the component by a user logged into the web server, and
the second computing infrastructure is configured to send to the first computing infrastructure, in response to the request, an order identifier for referencing a manufacturing order for additive manufacturing of the selected component.

23. The system according to claim 22, wherein:
the second computing infrastructure is configured to send the address together with the order identifier to the first computing infrastructure.

24. The system according to claim 16, wherein:
the additive manufacturing device associated with the logged-in user is specified by a data set stored in the first computing infrastructure and/or can be selected, specified and/or changed by means of the user interface by the logged-in user.

25. The system according to claim 16, wherein:
the component can be selected from a group of components by the user logged into the web server by means of the user interface, wherein instructions which cause an additive manufacturing device to additively manufacture the respective component in a plurality of layers are stored in a data memory of the first computing infrastructure for each selectable component of the group.

26. The system according to claim 16, wherein at least one of:
the second computing infrastructure is configured to communicate with the plurality of additive manufacturing devices via a virtual private network; and
the first computing infrastructure is configured to authenticate itself to the second computing infrastructure, and the second computing infrastructure is configured to authentificate the authenticating first infrastructure.

27. The system according to claim 26, wherein the second computing infrastructure is configured to communicate with the plurality of additive manufacturing devices via the virtual private network, only exclusively with the plurality of additive manufacturing devices within the plurality of local networks; and
the second computing infrastructure is configured to authentificate the authenticating first infrastructure via an access token.

28. The system according to claim 16, wherein:
the second computing infrastructure is configured to receive from the additive manufacturing device referenced in the manufacturing identifier an execution status indicating a status of an additive manufacturing of the selected component, and to send the received execution status to the first computing infrastructure.

29. The system according to claim 28, wherein:
the first computing infrastructure is configured to receive the execution status sent by the second computing infrastructure and to adjust an access right with which a selection of the component for the logged-in user is enabled, based on the received execution status.

30. The system according to claim 16, wherein:
an access right with which a selection of the component is enabled is modifiable via the user interface by the user logged into the web server.

31. The system according to claim 16, wherein:
the first computing infrastructure is associated with a manufacturer of an installation; and at least one of:
the second computing infrastructure is associated with a manufacturer of the additive manufacturing device, and
the additive manufacturing device is arranged in an installation of the manufacturer, which is assigned to the first computing infrastructure, as one of a wearing part supplier and a replacement part supplier.

32. The system according to claim 31, wherein the installation includes one of a production installation and a container-processing installation.

33. The system according to claim 16, wherein:
the component to be additively manufactured is a replacement part or a wearing part of a container-processing installation for processing containers.

34. The system of claim 33, wherein the replacement part or the wearing part includes one of a format part, a container guide rail, a container guide, a container holder, and a container clamp.

35. A computer-assisted method for additively manufacturing a component, comprising:
providing a first computing infrastructure with a web server that provides a user interface;
providing a second computing infrastructure that is connectable to a plurality of additive manufacturing devices of a plurality of local networks for operating the additive manufacturing devices;
receiving by means of the first computing infrastructure a selection of a component which has been selected by means of the user interface by a user logged into the web server;
sending from the first computing infrastructure to the second computing infrastructure instructions that prompt an additive manufacturing device to additively manufacture the selected component in a plurality of layers;
sending from the first computing infrastructure to the second computing infrastructure a manufacturer identifier that references an additive manufacturing device associated with the logged-in user; and
receiving the sent instructions by the second computing infrastructure;
receiving the sent manufacturer identifier by the second computing infrastructure; and
instructing by means of the second computing infrastructure the additive manufacturing device referenced in the received manufacturer identifier to additively manufacture the selected component according to the received instructions.
